(19) United States
(12) Patent Application Publication
(10) Pub. No.: US 2019/0138407 A1
(43) Pub. Date: May 9, 2019

(54) SYSTEMS AND METHODS OF DEPLOYING AN OPERATING SYSTEM FROM A RESILIENT VIRTUAL DRIVE

(71) Applicant: MICROSOFT TECHNOLOGY LICENSING, LLC, Redmond, WA (US)

(72) Inventors: Karan MEHRA, Sammamish, WA (US); Emanuel PALEOLOGU, Kirkland, WA (US); Tarun RAMANI, Redmond, WA (US)

(21) Appl. No.: 15/852,505

(22) Filed: Dec. 22, 2017

Related U.S. Application Data
(60) Provisional application No. 62/582,821, filed on Nov. 7, 2017.

(51) Int. Cl. G06F 11/16; G06F 3/06; G06F 9/4401; G06F 11/20

(52) U.S. Cl. CPC G06F 11/1662; G06F 3/065; G06F 3/0619; G06F 2201/82; G06F 9/4406; G06F 11/2094; G06F 2201/805; G06F 3/0689

(57) ABSTRACT

A computing device that runs an operating system (OS) in a resilient OS mode in which configuration parameters of the OS are accessible from multiple physical drives so that the computing device can continue to operate notwithstanding a failure to any one of the multiple physical drives. The computing device may be configured with a Virtual Drive to store duplicative copies of the OS and associated configuration parameters across at least two physical drives. The computing device may further be configured with a firmware interface that is deployable to initialize the OS by accessing the Virtual Drive to load the OS and associated configuration parameters into a memory of the computing device. Once initialized, the OS may be operated from the Virtual Drive so that interruption from a failure of any one of the at least two physical drives storing the OS is mitigated.

### PRIORITY APPLICATION

This application claims the benefit of and priority to U.S. Provisional Application No. 62/582,821, filed Nov. 7, 2017, the entire contents of which are incorporated herein by reference.

### BACKGROUND

Modern computing devices are designed to provide data resiliency to mitigate the risk of equipment failures or other system disruptions resulting in valuable data resources being lost. For example, data mirroring techniques can be deployed to create and maintain redundant copies of data files across multiple physical disks so that in the event of a single disk failure, the data files remain accessible from at least one other disk. Despite being widely configured to deploy data resiliency techniques to avoid costs associated with data resources being lost, modern computing devices remain highly susceptible to failures of operationally critical disks (e.g., a hard disk from which an operating system (OS) is run) which often results in costly downtime and productivity losses. When an operationally critical disk of a modern computing device fails, a user must typically embark on the laborious process of replacing the disk, re-installing the OS, accessing the redundant copies of the data files, and finally reconfiguring the computing device according to desired settings and/or organizational schemes. Accordingly, even though the user may not have suffered from lost data, the downtime that results from a drive failure will have cost the user in terms of productivity due to his or her regular value-added activities having been temporarily disrupted.

Without the ability to prevent the downtime resulting from a failure of an operationally critical disk, people typically are forced to deal with periodic productivity losses. Furthermore, as users typically make incremental modifications to their system settings based on preferences without keeping a detailed log of such changes, re-configuring their system settings after re-installing the OS is generally an inefficient and frustrating experience. It is with respect to these and other considerations that the disclosure made herein is presented.

### SUMMARY

This disclosure describes systems and techniques that enable an operating system (OS) to run in a resilient OS mode in which configuration parameters of the OS are accessible from multiple physical drives so that a computing device can continue to operate notwithstanding a failure to any one of the multiple physical drives. A computing device may be configured with a virtual drive to store duplicative copies of the OS and associated configuration parameters across at least two physical drives. In some examples, the computing device may include a first physical drive that is coupled to a first drive port and a second physical drive that is coupled to a second drive port. As a specific but nonlimiting embodiment, the computing device may include a first hard disk that is coupled to a first Serial AT Attachment (SATA) interface and a second hard disk that is coupled to a second SATA interface. The computing device may further be configured with a firmware interface that is deployable to initialize the OS by accessing the Virtual Drive to load the OS and associated configuration parameters into a memory of the computing device. Once initialized, the OS may be operated from the Virtual Drive so that a failure of any one of the at least two physical drives storing the OS does not disrupt operation of the OS. For example, continuing with the aforementioned specific embodiment, in the event that either one of the hard disks fail, the computing device is still capable of running the OS through whichever hard disk(s) remains operational.

In some implementations described herein, a computing device may establish operation of an OS in a resilient OS mode that corresponds to configuration parameters of the OS being accessible from multiple physical drives. While operating the OS in the resilient OS mode, the computing device may monitor operational statuses of the multiple physical drives to determine whether an operational status of any particular physical drive is associated with a transition from the resilient OS mode to a reduced OS resiliency mode that corresponds to the configuration parameters being inaccessible from the particular physical drive. For example, the computing device may operate the OS in the resilient OS mode during which the configuration parameters are accessible from a first physical drive and also a second physical drive. Then, the computing device may determine that an operational status of the second physical drive is associated with a transition from the resilient OS mode to the reduced OS resiliency mode. For example, the operational status may indicate that the configuration parameters are either no longer accessible via the second physical drive (e.g., due to a catastrophic drive failure such as a read-write head crash) or that there is a heightened probability that the configuration parameters will become inaccessible via the second physical drive (e.g., due to one or more signs of imminent drive failure). Determining the operational status may include receiving health data from the second physical drive and analyzing the health data to determine a probability that the transition from the resilient OS mode to the reduced OS resiliency mode will occur. For example, the health data may indicate that there is a fifty-percent chance that the second physical drive will fail within a threshold period of time (e.g., one hour, one day, one week, etc.) based on one or more signs of imminent failure (e.g., accumulation of bad disk sectors, data corruption, etc.).

Based on the determined operational status, the computing device may generate a notification to communicate information associated with the transition from the resilient OS mode to the reduced OS resiliency mode. As a more specific but nonlimiting example, the computing device may analyze the health data to determine that the probability of the transition from the resilient OS mode to the reduced OS resiliency mode exceeds a threshold probability. The notification may then indicate the probability of the transition to prompt mitigative action to be taken—if desired. The notification may be in the form of a desktop notification that pops up to inform a user of the computing device (or an administrator having responsibility of the computing device) that the second physical drive is likely to fail within the near future and that such a failure would result in the OS and/or configuration parameters being inaccessible from the second physical drive—thus resulting in the transition to the reduced OS resiliency mode. The notification may further indicate one or more remedial actions that can be taken to prevent the transition. For example, the notification may include a user interface element to enable selection of an intermediary storage location to which the configuration parameters may be duplicated. As a more specific but nonlimiting example, the computing device may include a third drive port that is a Secure Digital eXtended Capacity (SDXC) interface into which a user may plug-in a non-volatile memory card. In such a scenario, the user interface element may enable selection of the non-volatile memory card for duplication of the configuration parameters onto the non-volatile memory card so that, until the second physical drive fails and/or is removed from the computing device, the configuration parameters are accessible from any one of the first physical drive, the second physical drive, and the non-volatile memory card.

In some implementations, the computing device may be configured to automatically duplicate the configuration parameters of the OS onto a newly identified physical drive that has replaced another physical drive at a particular drive port. For example, in response to the notification (or spontaneously for that matter), a user may swap out the second physical drive for a third physical drive by decoupling the second physical drive from the second drive port and then coupling the third physical drive into the second drive port. The computing device may then identify that the third physical drive has been physically coupled to the same drive port (e.g., a physical slot into which a physical drive can be attached) that the second physical drive used to be. For example, the computing device may perform a targeted device discovery for a port identification number corresponding to the second drive port and discover the third physical drive rather than the second physical drive. In such a scenario, the computing device may interpret this physical swapping of drives at the second drive port (e.g., as identified by its corresponding port identification number) as an indication that the third physical drive is to replace the second physical drive. In response to this indication, the computing device may automatically duplicate the configuration parameters of the OS onto the third physical drive to reestablish operation of the OS in accordance with the resilient OS mode but with the configuration parameters being accessible from the first physical drive and the third physical drive rather than the first physical drive and the second physical drive. In some implementations, the computing device may further respond to the third physical drive physically replacing the second physical drive by automatically updating Virtual Drive metadata that at least partially defines a Virtual Drive that enables the computing device to operate the OS within the resilient OS mode (e.g., by enabling the computing device to access the OS and/or configuration parameters from multiple independently operable drives). In some implementations, automatically updating the virtual drive metadata may include automatically updating at least an instance of virtual drive metadata that is stored in association with a firmware interface in response to the third physical drive being swapped out for the second physical drive at the second drive port. Storing the virtual drive metadata in association with a firmware interface may include storing the virtual drive metadata on the firmware interface (e.g., by flashing the metadata onto one or more firmware variables) and/or storing the virtual drive metadata at one or more locations that are accessible by the firmware interface (e.g., by storing the metadata on a location of a physical drive that is accessible by the firmware interface).

In various implementations, failure of any particular physical drive does not prevent the computing device from booting and/or operating the OS, because the computing device is still able to boot and/or operate the OS in accordance with the reduced OS resiliency mode until a replacement physical drive is installed and configured appropriately. For example, in the event that the second physical drive catastrophically fails (e.g., the OS and its associated configuration parameters become wholly inaccessible from the second physical drive), the computing device may still remain completely operational from the perspective of a user because a firmware interface (e.g., a Unified Extensible Firmware Interface (UEFI)) may still boot the OS and configuration parameters into memory from the first physical drive. In particular, the firmware interface may be configured to selectively access physical drives via at least the first drive port and the second drive port. Furthermore, as described above, each of the first physical drive coupled to the first drive port and the second physical drive coupled to the second drive port store the configuration parameters corresponding to the OS. In some implementations, firmware interface system partitions (FISPs) storing the OS and its configuration parameters may be synchronized between each of the first physical drive and the second physical drive. The firmware interface may receive a signal that initializes loading of the OS into the memory of the computing device. The signal may result from, for example, a user pressing a power button on the computing device. In response to the signal, the firmware interface may determine operational statuses of the computing device's multiple physical drives that store the OS and its configuration parameters. Then, based on the determined operational statuses, the firmware interface may select an OS booting protocol from a plurality of different OS booting protocols. In various implementations, the plurality of OS booting protocols may include a first OS booting protocol associated with loading the OS into the memory from the first physical drive alone, a second OS booting protocol associated with loading the OS into the memory from the second physical drive alone, and a third OS booting protocol associated with loading the OS into the memory from both physical drives (e.g., concurrently loading different portions of the OS from different physical drives to speed up the booting process). Ultimately, the firmware interface may access whichever physical drive(s) are indicated by the selected OS booting protocol to load the OS into the memory of the computing device prior to passing control of the computing device over to the OS.

The disclosed systems and techniques mitigate the need for people and businesses to deal with periodic productivity losses resulting from failures to operationally critical drives. For example, the resilient OS mode described herein enables a computing device to withstand a catastrophic failure to a physical drive storing the OS because the Virtual Drive from which the OS is being operated is configured to seamlessly access the OS and associated configuration parameters from at least one other physical drive. Accordingly, the disclosed systems and techniques represent a substantial advance over conventional computing devices that are entirely dependent on continual operation of a single physical drive that is dedicated to running an OS.

It should be appreciated that any reference to “first,” “second,” etc. items and/or abstract concepts within the description is not intended to and should not be construed to necessarily correspond to any reference of “first,” “second,” etc. elements of the claims. In particular, within this Summary and/or the following Detailed Description, items and/or abstract concepts such as, for example, individual physical drives and/or drive ports may be distinguished by numerical designations without such designations corresponding to the claims or even other paragraphs of the Summary and/or Detailed Description. For example, any designation of a “first physical drive” and “second physical drive” within a paragraph of this disclosure is used solely to distinguish two different physical drives within that specific paragraph—not any other paragraph and particularly not the claims.

It should be appreciated that the above-described subject matter may also be implemented as a computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of concepts in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The Detailed Description is described with reference to the accompanying figures. In the figures, the left-most digit(s) of a reference number identifies the figure in which the reference number first appears. The same reference numbers in different figures indicate similar or identical items.

FIG. 1 illustrates an example computing architecture for a computing device that is configured to initialize and run an operating system (OS) in a resilient OS mode in which the OS and associated configuration parameters are accessible from multiple physical drives.

FIG. 2 illustrates an example computing architecture and associated graphical user interface (GUI) that corresponds to a computing device running an OS in the resilient OS mode in which the OS and associated configuration parameters are accessible from multiple physical drives.

FIG. 3 illustrates an example computing architecture and associated GUI that corresponds to the computing device of FIG. 2 running the OS in a reduced OS resiliency mode due to the OS and the configuration parameters becoming inaccessible from one of the multiple physical drives.

FIG. 4 illustrates an example computing architecture and associated GUI that corresponds to a computing device initializing an OS booting protocol while only an outdated instance of the OS is accessible due to the multiple physical drives becoming unsynchronized.

FIG. 5 is a flow diagram of an example method for generating a notification that an operational status of a particular physical drive is associated with a transition from the resilient OS mode to the reduced OS resiliency mode and then re-establishing the resilient OS mode after the particular physical drive is replaced.

FIG. 6 is a flow diagram of an example method for updating various address fields and/or write paths based on a replacement drive being installed into the computing device to replace an obsolete physical drive that is removed from the computing device.

FIG. 7 is a flow diagram of an example method for selecting an OS booting protocol based on operational statuses of the multiple physical drives that store the OS and/or configuration parameters that correspond to the OS.

### DETAILED DESCRIPTION

Examples described herein provide various techniques that enable an operating system (OS) to run in a resilient OS mode in which configuration parameters of the OS are accessible from multiple physical drives so that a computing device can continue to boot and operate notwithstanding a failure to any one of its multiple physical drives. The computing device may store duplicative copies of the OS and associated configuration parameters across at least two physical drives. According to some examples, the computing device may further be configured with a firmware interface that is deployable to initialize the OS by accessing one or both of the physical drives to load the OS and associated configuration parameters into a memory of the computing device. Once initialized, the firmware interface may pass off control of the computing device to the OS which may then be operated from either one of its two physical drives. Thus, according to the various techniques described herein, an instance in which the OS and/or associated configuration parameters becomes permanently and/or temporarily inaccessible from one or more physical drives storing the OS does not prevent initialization of and/or disrupt operation of the OS so long as the OS and associated configuration parameters remain accessible from at least one physical drive. Stated alternatively, if one or more physical drives fail, the computing device is still capable of operating in accordance with a reduced OS resiliency mode during which the OS can still be booted and run from whichever physical drive(s) remains operational.

Accordingly, the various techniques described herein mitigate the need for people and businesses to deal with periodic productivity losses that result from failures to operationally critical drives. In some examples, the resilient OS mode enables the computing device to withstand a catastrophic failure to a physical drive storing the OS because a Virtual Drive from which the OS can be booted and run is configured to enable seamless access to the OS and associated configuration parameters from at least one other physical drive. Stated alternatively, when operating in the resilient OS mode during which the OS and configuration parameters are accessible from multiple drives, none of these drives are “operationally critical” because failure of any individual drive does not impede operation of the computing device from the perspective of a user. Accordingly, the disclosed systems and techniques represent a substantial advance over conventional computing devices that are entirely dependent on continual operation of a single physical drive that is dedicated to running an OS.

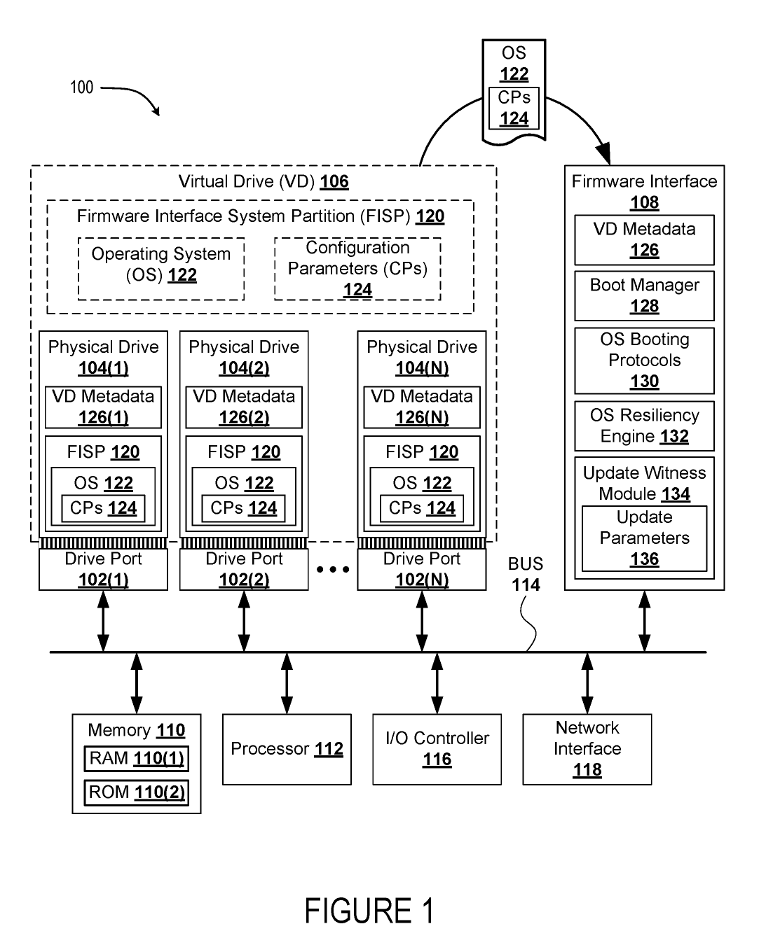

Turning now to FIG. 1, an example architecture is shown for a computing device 100 that is configured to initialize and run an operating system (OS) in a resilient OS mode in which the OS and/or associated configuration parameters are accessible from multiple physical drives. Thus, the computing device 100 can continue to operate notwithstanding a failure to any individual one(s) of the multiple physical drives. The example architecture enables the computing device 100 to execute any aspects of the software components and/or functionality presented herein. Furthermore, the example architecture illustrated in FIG. 1 shows an architecture for a personal computer (e.g., a laptop and/or desktop computer), a tablet computer, a smart phone, a server computer, a server rack, a network of server computers, or any other types of computing devices suitable for implementing the functionality described herein.

The computing device 100 illustrated in FIG. 1 includes multiple drive ports 102(1) through 102(N) each of which has coupled thereto a corresponding Physical Drive 104(1) through 104(N) having associated computer-readable media that provides nonvolatile storage for the computing device 100. Exemplary drive ports 102 include, but are not limited to, Serial AT Attachment (SATA) interfaces, Parallel AT Attachment (PATA) interfaces, Universal Serial Bus (USB) interfaces, MultiMediaCard (MMC) interfaces, Secure Digital (SD) interfaces (e.g., Secure Digital eXtended Capacity (SDXC) interfaces, etc.), and/or any other suitable interface for attaching a storage media to a computing device. Exemplary physical drives 104 include, but are not limited to, SATA-type solid-state hard drives, SATA-type hard disks, PATA-type solid-state hard drives, PATA-type hard disks, USB “flash” drives, SD non-volatile memory cards, and/or any other suitable physical drive for providing non-volatile computer-readable media to a computing device.

The computing device 100 further includes a Virtual Drive (VD) 106 that includes a combination of at least two of the physical drives 104. In the illustrated example, the Virtual Drive (VD) 106 includes at least a portion of a first physical drive 104(1), a second physical drive 104(2), and an N-th physical drive 104(N). The Virtual Drive (VD) 106 stores an operating system (OS) and/or associated configuration parameters to enable a firmware interface 108 to load the OS and associated configuration parameters into a memory 110. In the illustrated example, the memory 110 includes a random-access memory (“RAM”) 110(1) and a read-only memory (“ROM”) 110(2). As further illustrated, the computing device 100 includes a central processing unit (“CPU”) 112 that is connected, via a system bus 114, to the drive ports 102 (and therefore the multiple physical drives 104 and the Virtual Drive (VD) 106), the firmware interface 108, and the memory 110. As described above, the physical drives 104 and associated computer readable media provide non-volatile storage for the computing device 100.

Although the description of computer-readable media contained herein refers to a mass storage device, such as a solid-state drive and/or a hard disk, it should be appreciated by those skilled in the art that computer-readable media can be any available computer storage media or communication media that can be accessed by a computing architecture. Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner so as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer storage media includes, but is not limited to, RAM, ROM, EPROM, EEPROM, flash memory or other solid-state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computing device 100. For purposes of the claims, the phrase “computer storage medium,” “computer-readable storage medium” and variations thereof, does not include waves, signals, and/or other transitory and/or intangible communication media, per se.

The computing device 100 may also include an input/output controller 116 for receiving and processing input from a number of other devices, including a keyboard, mouse, or electronic stylus (not shown in FIG. 1). Similarly, the input/output controller 116 may provide output to a display screen, a printer, or other type of output device (also not shown in FIG. 1). The computing device 100 may also include a network interface 118 that enables the computing device 100 to connect to a network (not shown in FIG. 1) such as a local area network (LAN), a wide area network (WAN), a wireless local area network (WLAN), or any other suitable network for passing information between the computing device 100 and one or more other computing devices.

It should be appreciated that the software components described herein may, when loaded into the CPU 112 and executed, transform the CPU 112 and the overall computing device 100 from a general-purpose computing system into a special-purpose computing system customized to facilitate the functionality presented herein. The CPU 112 may be constructed from any number of transistors or other discrete circuit elements, which may individually or collectively assume any number of states. More specifically, the CPU 112 may operate as a finite-state machine, in response to executable instructions contained within the software modules disclosed herein. These computer-executable instructions may transform the CPU 112 by specifying how the CPU 112 transitions between states, thereby transforming the transistors or other discrete hardware elements constituting the CPU 112.

As described above, the computing device 100 is configured to redundantly store an operating system (OS) 122 and/or associated configuration parameters (CPs) 124 across at least two physical drives 104 so that the OS 122 can be operated in a resilient OS mode. In the illustrated example, the OS 122 and configuration parameters (CPs) 124 are stored in the Virtual Drive (VD) 106 which includes at least a portion of the first physical drive 104(1), the second physical drive 104(2), and the N-th physical drive 104(N). The Virtual Drive (VD) 106 may be configured to provide redundancy according to any number of suitable techniques. For example, the Virtual Drive (VD) 106 may be configured as a mirror space that is designed to provide redundancy by storing multiple copies of individual files across the different physical drives 104 such that one or more of the physical drives 104 can fail (or become temporarily inaccessible) without impacting the ability of the computing device 100 to readily access the OS 122 and its associated configuration parameters (CPs) 124. As another example, the Virtual Drive (VD) 106 may be configured as a parity space that is designed to keep single copies of individual files along with parity information to protect against failure of any single one of the physical drives 104. It can be appreciated that depending upon various design considerations, a variety of redundancy techniques can be selected and deployed to cause the computing device 100 to automatically monitor the contents of the Virtual Drive (VD) 106 to maintain integrity and prevent file corruption of the OS 122 and configuration parameters (CPs) 124.

In some embodiments, the computing device 100 stores Virtual Drive metadata (VD Metadata 126) that indicates relationships between the various physical drives 104 to define the Virtual Drive (VD) 106. For example, the VD Metadata 126 may indicate address information associated with each of the first physical drive 104(1), the second physical drive 104(2), and the N-th physical drive 104(N). The VD Metadata 126 may define the Virtual Drive (VD) 106 by associating each of the first physical drive 104(1), the second physical drive 104(2), and the N-th physical drive 104(N) with one another. Accordingly, since the Virtual Drive (VD) 106 is configured to redundantly store the OS 122 and/or associated configuration parameters (CPs) 124, the VD metadata 126 may be usable by the computing device 100 to identify specific address information associated with an accessible instance of the OS 122 and/or configuration parameters (CPs) 124 that is stored on an operational physical drive notwithstanding permanent and/or temporary accessibility of another physical drive.

In some examples, the Virtual Drive (VD) 106 is configured to synchronize a Firmware Interface System Partition (FISP) 120 across two or more of the physical drives 104 that are designated for inclusion within the Virtual Drive (VD) 106. In this way, the FISP 120 is redundantly stored across at least two of the physical drives 104 so that if the FISP 120 becomes inaccessible from any particular physical drive 104, the computing device 100 may seamlessly access the FISP 120 from one or more other physical drives 104. In the illustrated example, the FISP 120 that is synchronized across the physical drives 104 includes the OS 122 and associated configuration parameters (CPs) 124. Exemplary FISPs 120 include, but are not limited to, EFI system partitions (ESPs)—where EFI stands for “Extensible Firmware Interface”, Basic Input/Output System (BIOS) boot partitions, or any other suitable partition format suitable for storing boot loaders and/or system root directories.

In some examples, the firmware interface 108 defines a software interface between the OS 122 and associated configuration parameters (CPs) 124 and firmware of the computing device 100 to facilitate various boot services while the firmware controls the computing platform. In some examples, the firmware interface 108 may further define runtime services that remain accessible after control of the computing platform has been passed over to the OS 122. Exemplary firmware interfaces 108 include, but are not limited to, Extensible Firmware Interfaces (EFIs), Unified Extensible Firmware Interfaces (UEFIs), BIOS firmware interfaces, and/or any other firmware interface suitable for providing functionality described herein.

In some examples, the firmware interface 108 includes a Boot Manager 128 which is configured to access the OS 122 and configuration parameters (CPs) 124 from one or more of the physical drives 104. Ultimately, the boot manager 128 may load the OS 122 and configuration parameters (CPs) 124 into the memory 110 for runtime execution by the computing device 100 (e.g., by invoking an OS boot loader). The boot manager 128 may select from a plurality of OS Booting Protocols 130 based on a variety of factors such as, for example, operational statuses of the physical drives 104 and/or user preferences. In some implementations, the firmware interface 108 may receive a signal that initiates loading of the OS 122 into the memory 110. Responsive to the signal, the boot manager 128 may determine operational statuses for at least some of the physical drives 104. Then, based on the operational statuses, the boot manager 128 may select a particular OS booting protocol to implement for loading the OS 122 into the memory 110. In some examples, the boot manager 128 may further select the particular OS booting protocol based on an analysis of the VD metadata 126. In the illustrated example, a copy of the VD metadata 126 is stored at the firmware interface 108 and is accessible by the various components of the firmware interface 108. As a more specific but nonlimiting example, the boot manager 128 may respond to the signal by analyzing the VD metadata 126 to determine the address information associated with the various physical drives 104 that are included within the Virtual Drive (VD) 106. Upon determining which physical drives 104 are included within the Virtual Drive (VD) 106, the boot manager 128 may determine an operational status for each of these physical drives 104. If the operational status for any individual physical drive indicates that the OS 122 and/or configuration parameters (CPs) 124 are currently inaccessible from that individual physical drive, then the boot manager 128 may select an OS booting protocol that does not depend upon the inaccessible physical drive.

Accordingly, it can be appreciated that in the illustrated example in which the OS 122 and configuration parameters (CPs) 124 are redundantly stored across each of the first physical drive 104(1), the second physical drive 104(2), and the N-th physical drive 104(N), permanent and/or temporarily failure of any individual one of the illustrated physical drives 104 will not prevent the OS 122 from being successfully booted into the memory 110. For example, as illustrated in FIG. 1, the firmware interface 108 is configured to access to the OS 122 and/or configuration parameters (CPs) 124 from the Virtual Drive (VD) 106 (that is configured to be resilient to drive failures) rather than relying on a single dedicated system drive (e.g., a single disc and/or partition thereof designated as a C: drive) similar to conventional computing devices.

In some examples, the firmware interface 108 includes an OS Resiliency Engine 132 that enables the computing device 100 to continue to run the OS 122 even if one or more individual physical drives fail while the OS 122 is running on the computing device 100. For example, suppose that the computing device 100 is running the OS 122 from the Virtual Drive (VD) 106 at a time when all three of the illustrated physical drives are operational. Suppose then that an operational state of the second physical drive 104(2) changes so that the second physical drive 104(2) becomes inaccessible. For example, the second physical drive 104(2) may suffer from a catastrophic failure such as, for example, a read-write head crash while the computing device 100 is running the OS 122. In this scenario, the OS resiliency engine 132 may be continually monitoring the operational statuses of the physical drives 104 and, upon determining that the second physical drive 104(2) has become inaccessible, the OS resiliency engine 132 may automatically update the VD metadata 126 to redefine the Virtual Drive (VD) 106 as corresponding to the first physical drive 104(1) and the N-th physical drive 104(N) but not the second physical drive 104(2). In some implementations, automatically updating the VD metadata 126 includes automatically re-flashing at least a portion of the firmware interface 108 with updated VD metadata 126 indicating that the Virtual Drive (VD) 106 now corresponds to first physical drive 104(1) and the N-th physical drive 104(N) but not the second physical drive 104(2).

In some examples, the firmware interface 108 includes an Update Witness Module 134 that is configured to access (e.g., write to and/or read from) a firmware variable during operation of the OS 122 to record Update Parameters 136 associated with one or more updates to the OS 122 and/or configuration parameters (CPs) 124. For example, while the computing device 100 is operating the OS 122 from the Virtual Drive (VD) 106, an update to the OS 122 may be received over a network and installed onto one or more of the physical drives 104. As a more specific but nonlimiting example, the OS 122 may be updated from WINDOWS 8.1 to WINDOWS 10. In this example, the update witness module 134 may modify the update parameters 136 to reflect that the OS 122 has been updated to WINDOWS 10. As another example, while the computing device 100 is operating the OS 122 from the Virtual Drive (VD) 106, a user may change one or more of the configuration parameters (CPs) 124 based on his or her user preferences. As a more specific but nonlimiting example, the user may modify the configuration parameters (CPs) 124 from making a series of changes to a directory structure and/or folder hierarchy that is used to define storage locations for a plurality of media files on the computing device 100. In this example, the update witness module 134 may modify the update parameters 136 to reflect that the user has modified the directory structure and/or folder hierarchy to organize the plurality of media files.

Under a variety of circumstances, updates to the OS 122 and/or the configuration parameters (CPs) 124 may cause the physical drives 104 to become unsynchronized as the updates are written to some but not all of the physical drives 104. For example, suppose that the computing device 100 is running the OS 122 from the Virtual Drive (VD) 106 at a time when only the first physical drive 104(1) is currently accessible (e.g., the second physical drive 104(2) and the N-th physical drive 104(N) may both be hard disks nearing the end of their useful lives such that the drives periodically stop responding). Further suppose that a user makes changes to the directory structure and/or folder hierarchy of the OS 122 while only the first physical drive 104(1) is accessible. Under these circumstances, the update witness module 134 may modify the update parameters 136 to indicate that changes to the OS 122 and/or configuration parameters (CPs) 124 have been written to the first physical drive 104(1).

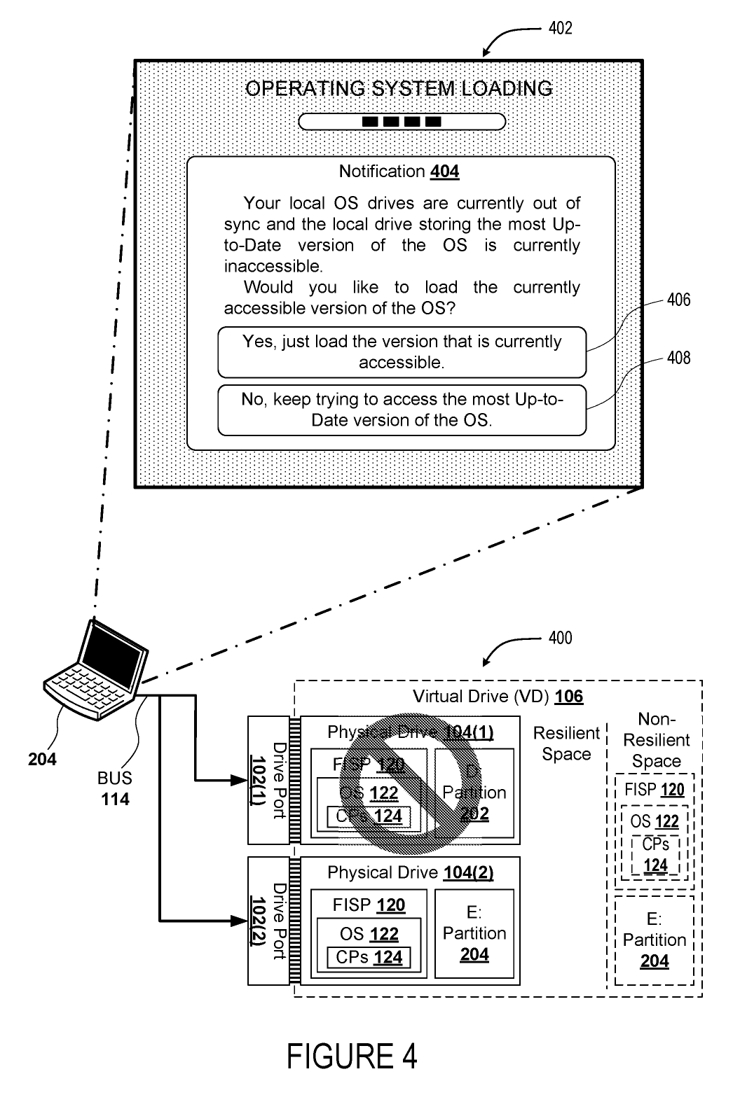

Due to the update parameters 136 being stored at the firmware interface 108, the computing device 100 may access the update parameters 136 prior to initializing the OS 122 (e.g., prior to or during a boot process) to determine whether the physical drives 104 are currently synchronized with respect to any updates having previously occurred to the OS 122 and/or the configuration parameters (CPs) 124. For example, continuing with the previous scenario, further suppose that the computing device 100 is shut down prior to the updates that were made to the first physical drive 104(1) being synchronized with the remaining physical drives. Thus, the changes to the directory structure and/or folder hierarchy of the OS 122 that were made by the user while only the first physical drive 104(1) was accessible have not been written to either the second physical drive 104(2) or the N-th physical drive 104(N). Further suppose that the user later attempts to turn on the computing device 100 and for some reason the first physical drive 104(1) is not responding. Since the updates made by the user have been written only to a physical drive that is now inaccessible (i.e., the first physical drive 104(1)) simply loading the OS 122 and configuration parameters (CPs) 124 into the memory 110 from the now available physical drive(s) would result in an outdated version of the OS 122 being initialized. Furthermore, since there is no record of the updates on the now available physical drives, the computing device 100 would be unable to determine from the physical drives 104 alone that the available version of the OS 122 and configuration parameters (CPs) 124 is outdated. Accordingly, the boot manager 128 may access the update parameters 136 to determine whether the currently available instances of the OS 122 and configuration parameters (CPs) 124 (i.e., a second instance stored on the second physical drive 104(2) and an N-th instance stored on the N-th physical drive 104(N)) are outdated with respect to any currently unavailable instances of the OS 122 and configuration parameters (CPs) 124 (i.e., a first instance stored on the first physical drive 104(1)). As will be described in more detail with respect to FIG. 4, in various embodiments the computing device 100 and/or firmware interface 108 thereof may be configured to notify a user that the most Up-to-Date version of the OS 122 and/or configuration parameters (CPs) 124 is currently unavailable.

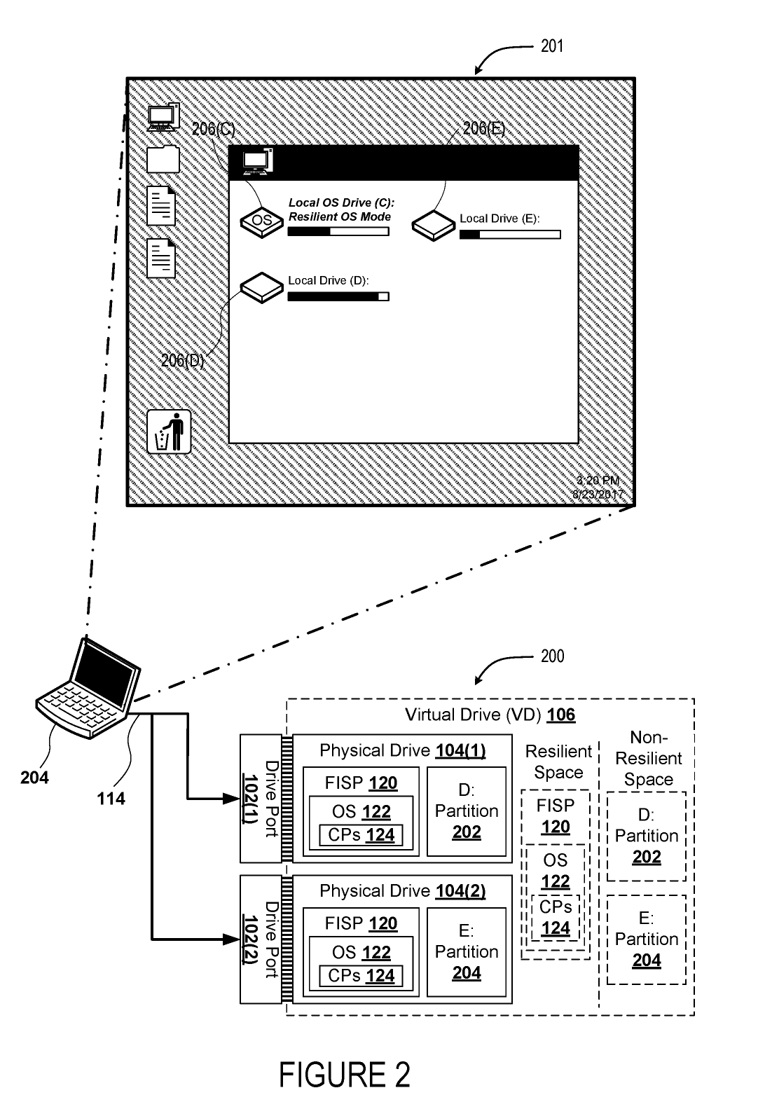

Turning now to FIG. 2, illustrated is an example computing architecture 200 and associated graphical user interface (GUI) 202 that corresponds to a computing device 204 running the OS 122 in the resilient OS mode in which the OS 122 and the configuration parameters (CPs) 124 are accessible from multiple physical drives 104. In the illustrated embodiment, the computing architecture 200 includes multiple drive ports 102, each of which has coupled thereto a corresponding physical drive 104. Specifically, the computing architecture 200 includes a first physical drive 104(1) coupled to a first drive port 102(1) and a second physical drive 104(2) coupled to a second drive port 102(2). As further illustrated, the first physical drive 104(1) and the second physical drive 104(2) are designated for inclusion within a Virtual Drive (VD) 106 that includes resilient space corresponding to data that is resiliently stored across the first physical drive 104(1) and the second physical drive 104(2). For example, the resilient space of the Virtual Drive (VD) 106 is shown to include the FISP 120 which stores both the OS 122 and configuration parameters (CPs) 124. The Virtual Drive (VD) 106 further includes non-resilient space corresponding to data that is not resiliently stored across the first physical drive 104(1) and the second physical drive 104(2). For example, in the illustrated embodiment, the first physical drive 104(1) includes a “D:” partition 202 and the second physical drive 104(2) includes an “E:” partition 204 neither of which are redundantly stored across both physical drives 104. Since these partitions are not redundantly stored across both drives, they are shown as non-resilient space within the Virtual Drive (VD) 106.

Referring now to the GUI 201 of FIG. 2, various user interface elements (UIEs) 206 are shown that correspond to the various partitions stored by the first physical drive 104(1) and the second physical drive 104(2). More specifically, UIE C 206(C) is shown to graphically represent a local OS Drive of the computing architecture 200. It can be appreciated that although the local OS drive is pictorially represented as the “C:” drive, the designation depicted is for illustrative purposes only and is not to be construed as a limitation. Additionally, UIE D 206(D) is shown to graphically represent the “D:” partition 202 that is stored solely on the first physical drive 104(1) and UIE E 206(E) is shown to graphically represent the “E:” partition 204 that is stored solely on the second physical drive 104(2). In various embodiments, the computing device 204 may be configured to indicate to a user and/or administrator whether the OS is currently being run in the resilient OS mode or the reduced OS resiliency mode. For example, as illustrated, the UIE C 206(C) includes a textual indication that the OS is currently being run in the resilient OS mode such that a failure of either one of the physical drives 104 will not impede continual operation of the OS 122. Rather, the OS 122 will continue to seamlessly operate (albeit in a reduced OS resiliency mode) so long as at least one of the physical drives 104 remains operational.

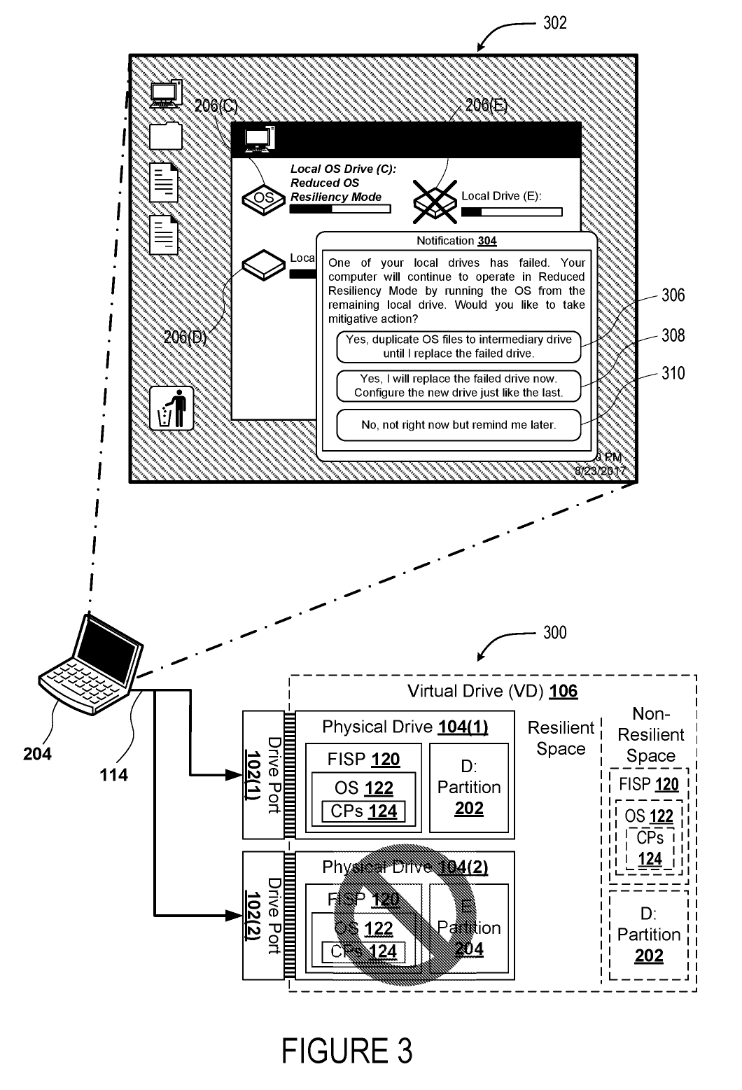

Turning now to FIG. 3, illustrated is an example computing architecture 300 and associated graphical user interface (GUI) 302 that corresponds to the computing device 204 running the OS 122 in the reduced OS resiliency mode due to the OS 122 and the configuration parameters (CPs) 124 becoming inaccessible from one of the multiple physical drives 104. The computing architecture 300 is similar to the computing architecture 200 with the exception that the second physical drive 104(2) has failed. Accordingly, in contrast to the computing architecture 200, in the computing architecture 300 the FISP 120 is no longer resiliently stored across the first physical drive 104(1) and the second physical drive 104(2). In FIG. 3, therefore, the FISP 120 is shown to be included within the non-resilient space of the Virtual Drive (VD) 106 along with the “D:” partition 202. Furthermore, the “E:” partition 204 is no longer available within the Virtual Drive (VD) 106 and the resilient space is shown to be null or empty.

Referring now to the GUI 302 of FIG. 3, the UIE C 206(C) and UIE E 206(E) are shown to have been modified based on the second physical drive 104(2) having failed. In particular, the UIE C 206(C) is shown with the textual indication now indicating to the user that the OS 122 is being run in the reduced OS resiliency mode. In this scenario, since only the first physical drive 104(1) remains operational, the OS 122 will not be able to seamlessly operate in the event of another drive failure. In some implementations, the GUI 302 includes a notification 304 that indicates to a user of the computing device 204 that one or more of the physical drives 104 has failed. The notification 304 may further indicate to the user that the failure of the physical drive 104 will not prevent operation of the computing device 204 (e.g., since the OS 122 and configuration parameters are still accessible from the first physical drive 104(1)) but that continued operation of the computing device 204 will be in the reduced OS resiliency mode that is relatively more susceptible to physical drive issues than the resilient OS mode.

In some examples, the notification 304 may inquire as to whether the user would like to take one or more suggested mitigative actions. For example, in the illustrated embodiment, the notification 304 includes a plurality of user interface elements (UIEs) (labeled 306, 308, and 310) that are selectable by the user to initiate one or more of the suggested mitigative actions or to instruct that no mitigative action should be taken at this time.

With particular reference to UIE 306, one exemplary mitigative action may include duplicating OS files (e.g., the OS 122 and configuration parameters 124) to an intermediary drive at least until the second physical drive 104(2) is decoupled from the second drive port 102(2) and a replacement drive coupled in its place has the OS files written thereto. For example, in addition to the first drive port 102(1) and the second drive port 102(2), the computing device 204 may include a third drive port (not shown) such as a USB-type interface and/or an SDXC interface into which the user can attach a removable storage device. Accordingly, in order to regain operation of the OS 122 in the resilient OS mode, the user may plug-in the removable storage device and instruct the computing device 204 to duplicate the OS 122 and its corresponding configuration parameters (CPs) 124 onto the removable storage device. The computing device 204 may also update the VD metadata 126 as appropriate to redefine the Virtual Drive (VD) 106 as corresponding to the first physical drive 104(1) and the newly identified removable storage device and not the failed second physical drive 104(2).

With particular reference to UIE 308, another exemplary mitigative action may include replacing the failed drive right away and instructing the computing device 204 to configure the new drive according to the computing architecture 200 during which the resilient OS mode is available. In particular, the computing device 204 may monitor the second drive port 102(2) to determine when the second physical drive 104(2) has been replaced by a third physical drive (not shown) that is operational. Once the third physical drive becomes available for use by the computing device 204, VD metadata 126(3) (not shown) that corresponds to the third physical drive may be written to the third physical drive and the firmware interface 108 to redefine the Virtual Drive (VD) 106 as corresponding to the first physical drive 104(1) and the third physical drive 104(3).

Although the notification 304 is shown to be graphically displayed within the GUI 302 at the computing device 204, in various other examples the notification 304 may be transmitted to an administrator account associated with the computing device 204. For example, an enterprise may have an IT department having one or more administrators that are responsible for ensuring the continual operation of numerous computing devices including the computing device 204. In such a scenario, upon the second physical drive 104(2) failing at the computing device 204, notification data may be transmitted by the computing device 204 to the IT department (e.g., in the form of an email and/or dashboard data) to prompt an administrator to take corrective action if appropriate.

Turning now to FIG. 4, illustrated is an example computing architecture 400 and associated GUI 402 that corresponds to a computing device 204 initializing an OS booting protocol 130 while only an outdated instance of the OS 122 is accessible (e.g., due to the multiple physical drives 104 becoming unsynchronized). As described above, updates to the OS 122 and/or the configuration parameters (CPs) 124 may cause the physical drives 104 to become unsynchronized as the updates are written to some but not all of the physical drives 104. The computing architecture 400 is similar to the computing architecture 200 with the exception that the first physical drive 104(1) has failed. Accordingly, the FISP 120 is shown to be included within the non-resilient space of the Virtual Drive (VD) 106 along with the “E:” partition 204. For purposes of FIG. 4, assume that the most recent updates to the OS 122 and/or the configuration parameters (CPs) 124 were received at a time when the first physical drive 104(1) was accessible but the second physical drive 104(2) was inaccessible such that the updates were successfully written to the first physical drive 104(1) but not the second physical drive 104(2). Further assume that the computing device 204 was shut down prior to the second physical drive 104(2) becoming accessible. Accordingly, the scenario illustrated in FIG. 4 corresponds to the computing device 204 being restarted and/or powered on at a time when the most Up-to-Date version of the OS 122 and/or configuration parameters (CPs) 124 are stored exclusively on the first physical drive 104(1) which is currently inaccessible.

Referring now to the GUI 402 of FIG. 4, a notification 404 is displayed while the computing device 204 is in the process of booting up the OS 122 when only the outdated instance of the OS 122 and/or configuration parameters (CPs) 124 are accessible. In particular, the only instance of the OS 122 and/or configuration parameters (CPs) 124 accessible is stored on the second physical drive 104(2) to which the most recently applied updates have not been written. The notification 404 is shown to indicate that the local physical drives that are configured to store the OS 122 and configuration parameters (CPs) 124 have become unsynchronized (e.g., due to updates being stored to one but not both of the local physical drives). The notification 404 is further shown to indicate that the physical drive that has had the most recently applied updates written thereto is not currently accessible. As described above, the update witness module 134 may continually modify the update parameters 136 while the OS 122 is being operated to provide information to the firmware interface 108 as to whether the physical drives are synchronized or unsynchronized. If the physical drives are unsynchronized, the update parameters 136 inform the firmware interface 108 and/or boot manager 128 thereof as to which updates have been written to which physical drives. Accordingly, the firmware interface 108 is able to access the update parameters 136 to determine whether the most Up-to-Date instance of the OS 122 and/or configuration parameters (CPs) 124 is written to one or more currently accessible physical drives.

Referring specifically to UIE 406, the notification 404 may in some examples inquire as to whether the user would like to load a currently accessible but out-of-date version of the OS 122 and/or configuration parameters (CPs) 124. Furthermore, referring specifically to UIE 408, the notification 404 may in some examples inquire as to whether the user would like the firmware interface 108 and/or boot manager 128 to re-attempt accessing the “most Up-to-Date” version of the OS 122 and/or configuration parameters (CPs) 124 rather than loading the currently accessible but out-of-date version of the OS 122 and/or configuration parameters (CPs) 124.

In some examples, the configuration parameters (CPs) 124 of the OS 122 may correspond to contents of the RAM 110(1) at a specific time. For example, a user may instruct the computing device 204 to suspend the contents of the RAM 110(1) to a physical drive and then to shut itself down. Stated alternatively, a user may instruct the computing device 204 to enter a “hibernation” state during which the contents of the RAM 110(1) at a designated specific time are stored on a physical drive to be subsequently re-loaded into the RAM 110(1) when the computing device 204 is instructed to “wake-up” from the hibernation state. Under various circumstances, a user may instruct the computing device 204 to enter the “hibernation” state at a time when the second physical drive 104(2) is inaccessible and then subsequently instruct the computing device 204 to wake-up from the “hibernation” state at a time when the first physical drive 104(1) (which the contents of the RAM 110(1) are stored to) is inaccessible. Under such circumstances, the notification 404 may indicate that the suspended contents of the RAM 110(1) are not currently available and, therefore, the computing device 204 is currently unable to re-enter the previous state from which the user instructed the computing device 204 to hibernate. Furthermore, the notification 404 may inquire as to whether the user would like to reboot the OS 122 into a standard OS initialization state (i.e., boot up the OS 122 as normal without then loading the suspended RAM contents) and/or whether the user would like the computing device 204 to re-attempt accessing the suspended RAM contents to wake-up from the “hibernation” state.

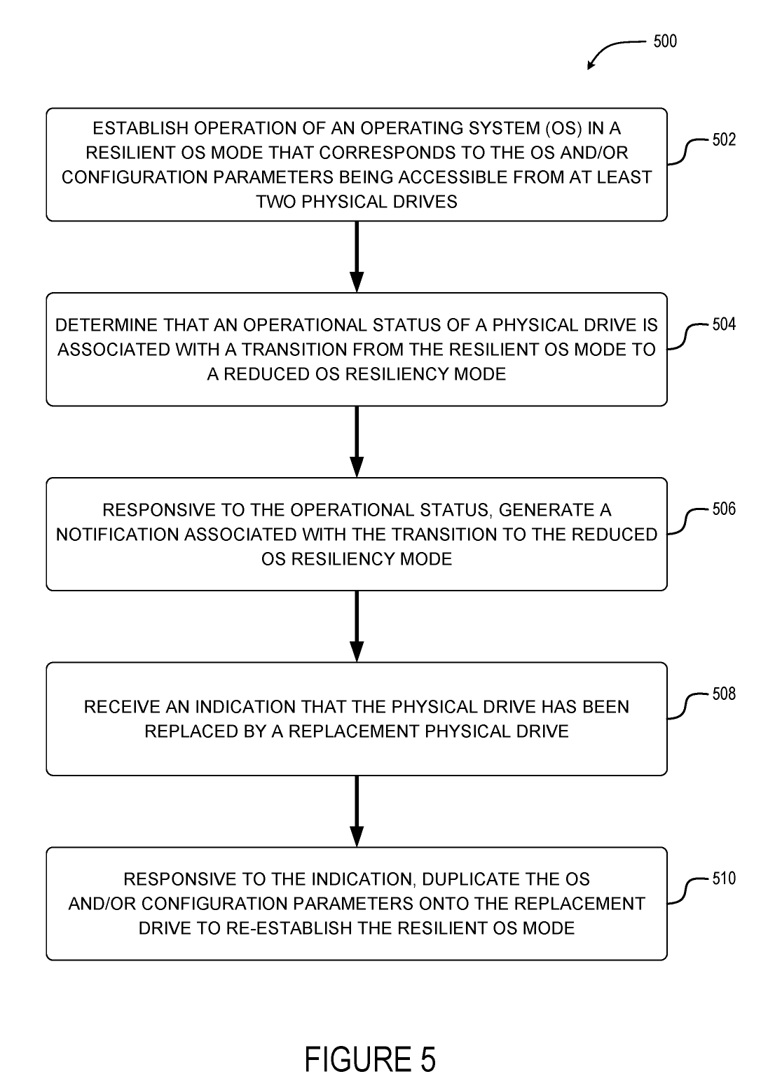

FIGS. 5-7 illustrate example flowcharts that are described with reference to FIGS. 1 through 4. It should be understood by those of ordinary skill in the art that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, performed together, and/or performed simultaneously, without departing from the scope of the appended claims.

It also should be understood that the illustrated methods can end at any time and need not be performed in their entireties. Some or all operations of the methods, and/or substantially equivalent operations, can be performed by execution of computer-executable instructions included on a computer-storage media, as defined herein. The term “computer-executable instructions,” and variants thereof, as used in the description and claims, is used expansively herein to include routines, applications, application modules, program modules, programs, components, data structures, algorithms, and the like. Computer-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

FIG. 5 is a flow diagram of an example method 500 for generating a notification that an operational status of a particular physical drive is associated with a transition from a resilient OS mode to a reduced OS resiliency mode and then re-establishing the resilient OS mode after the particular physical drive is replaced.

At block 502, a computing device 204 may establish operation of the OS 122 in the resilient OS mode. For example, the computing device 204 may operate the OS 122 from the Virtual Drive (VD) 106 that redundantly stores the OS 122 and configuration parameters (CPs) 124 across multiple physical drives 104. In this way, operation of the OS 122 is “resilient” in the sense that if any individual physical drive becomes permanently and/or temporarily inaccessible, operation of the OS 122 will not be impaired from the standpoint of a user.

At block 504, the computing device 204 may determine that an operational status of an individual one of the multiple physical drives 104 is associated with a transition from the resilient OS mode to a reduced OS resiliency mode. For example, it may be determined that the individual physical drive is completely inoperable due to a catastrophic drive failure such as, for example, a read-write head crash. Under these circumstances, the computing device 204 may determine that the operational status of the individual physical drive has already resulted in the transition from the resilient OS mode to the reduced OS resiliency mode. As another example, it may be determined that the individual physical drive remains operational but is beginning to experience operational issues that are indicative of an increased probability that the transition from the resilient OS mode to the reduced OS resiliency mode will occur. For example, the computing device 204 may receive health data corresponding to individual ones of the multiple physical drives 104 and determine, based on the health data, a probability that the transition will occur. Exemplary health data may include Self-Monitoring, Analysis, and Reporting Technology (S.M.A.R.T.) data that is generated by individual hard drives to gauge their own reliability and to determine whether they are failing. It can be appreciated that analysis of an individual hard drive's S.M.A.R.T. data may enable the computing device 204 to determine whether the individual hard drive is starting to develop problems even before it becomes inoperable.

In some implementations, the determined operational statuses may correspond to temperatures of the individual physical drives, latencies of the individual physical drives, and/or warranty statuses of the individual physical drives. For example, the computing device 204 may determine that an individual physical drive is running at a heightened temperature, is running at a lower speed than expected (e.g., as compared to one or more other physical drives connected to the system), or is running after its warranty has expired or is about to expire.

In some implementations, determining that the operational status of the individual physical drive is associated with the transition may include determining that the individual physical drive has been decoupled from a respective drive port. For example, a fully functional physical drive may be manually removed from the computing device 204 by a user for any number of reasons (e.g., to upgrade from a SATA hard-disk to a SATA solid state drive). In such an example, the computing device 204 may identify the removal of the drive (which of course results in the drive being inoperable from the standpoint of the computing device 204) and based on the removal determine that the transition to the reduced OS resiliency mode has occurred.

At block 506, the computing device 204 may generate a notification associated with the transition from the resilient OS mode to the reduced OS resiliency mode. For example, as described in relation to FIG. 3, a notification 304 may indicate that the individual hard drive has failed and that the computing device 204 may continue to operate but only within the reduced OS resiliency mode rather than the resilient OS mode. In some examples, the notification may indicate that the individual hard drive remains operational but that its corresponding operational status (e.g., as indicated by the health data) is indicative of a heightened probability that the transition from the resilient OS mode to the reduced OS resiliency mode will occur. In some embodiments, the notification generated at block 506 may be responsive to a determination that the heightened probability that the transition will occur exceeds a threshold probability that the individual drive will fail within a particular period of time. As a more specific but nonlimiting example, the computing device 204 may determine based on the S.M.A.R.T. data that there is a twenty-percent (20%) chance that the individual drive will fail within one month.

At block 508, the computing device 204 may receive an indication that the individual physical drive having the operational status associated with the transition has been replaced by a replacement physical drive. In some examples, the indication may correspond to the replacement physical drive being coupled to a particular drive port that the individual physical drive was coupled to when the operational status was determined at block 504. As a more specific but nonlimiting example, the computing device 204 may include a first physical drive 104(1) that is coupled to a first drive port 102(1) and a second physical drive 104(2) that is coupled to a second drive port 102(2). In such an example, at block 504 it may be determined that the second physical drive 104(2) has failed and that this has resulted in the transition to the reduced OS resiliency mode. Then, at block 508 the computing device 204 may determine that a third physical drive that is operational has been coupled into the second drive port 102(2). In some implementations, the computing device 204 may be configured to conclude under these circumstances that the third physical drive that is operational is intended to replace the second physical drive that previously failed. Stated alternatively, the computing device 204 may automatically conclude that the third physical drive is a replacement for the second physical drive based on the third physical drive being “plugged into” the same port from which the second physical drive was removed.

In some implementations, rather than automatically concluding that the third physical drive is intended to replace the second physical drive, the computing device 204 may be configured to indicate to a user and/or administrator that the third physical drive has been detected at the second drive port and inquire of a user and/or administrator whether the third physical drive is intended to replace the second physical drive.

At block 510, the computing device 204 may respond to the indication by duplicating the OS 122 and/or configuration parameters (CPs) 124 onto the replacement physical drive to re-establish operation of the OS 122 within the resilient OS mode. For example, continuing with the nonlimiting example in which the second physical drive 104(2) fails and is replaced by the third physical drive, the computing device 204 may update Virtual Drive parameters (e.g., the VD metadata 126) that define the Virtual Drive (VD) 106 to indicate that the third physical drive corresponds to the Virtual Drive (VD) 106. Then, once the Virtual Drive parameters have been updated and the OS 122 and/or configuration parameters (CPs) 124 been duplicated onto the third physical drive, the computing device may establish operation of the OS 122 from the Virtual Drive (VD) 106 that now redundantly stores OS 122 and/or configuration parameters (CPs) 124 across the first physical drive 104(1) and the third physical drive. At this point, operation of the OS 122 is once again “resilient” in the sense that if any individual physical drive becomes permanently and/or temporarily inaccessible, operation of the OS 122 will not be impaired from the standpoint of a user. In some implementations, the Virtual Drive parameters may be stored in association with a firmware interface and the computing device 204 may automatically update the Virtual Drive parameters responsive to a determination that the third physical drive has replaced the second physical drive 104(2) at a particular drive port. For example, in an implementation in which the Virtual Drive parameters (e.g., the VD metadata 126) are stored on the firmware interface (e.g., a UEFI or any other firmware interface that is suitable for assisting in booting an OS at a computing device), the computing device 204 may automatically update one or more portions of the firmware interface in response to the determination that the third physical drive has replaced the second physical drive 104(2). Accordingly, it can be appreciated that the present techniques enable various portions of the firmware interface to be automatically updated based on a physical drive being removed from a computing device, a physical drive being coupled to a computing device, and even based on which specific drive port a physical drive has been removed from and/or coupled to.

In some implementations, the computing device 204 may be configured such that the individual physical drive may be removed from a particular drive port and the replacement physical drive may be attached to the particular drive port without the computing device 204 being shut down. In particular, the computing device 204 may be configured such that the physical drives 104 may be “hot-swapped” without interrupting operation of the computing device 204. Thus, the operations corresponding to blocks 502 through block 510 may occur sequentially without the computing device 204 being powered down. In some implementations, the computing device 204 may be shut down and then rebooted between one or more operations of the example method 500. As a more specific but nonlimiting example, subsequent to the notification being generated at block 506, a user may power down the computing device 204 and swap out the individual hard drive for the replacement drive. Then, the indication may be received at block 508 upon the computing device being restarted after the replacement drive is installed. For example, the firmware interface 108 may perform an OS booting protocol 130 that includes “discovering” at least the replacement drive.

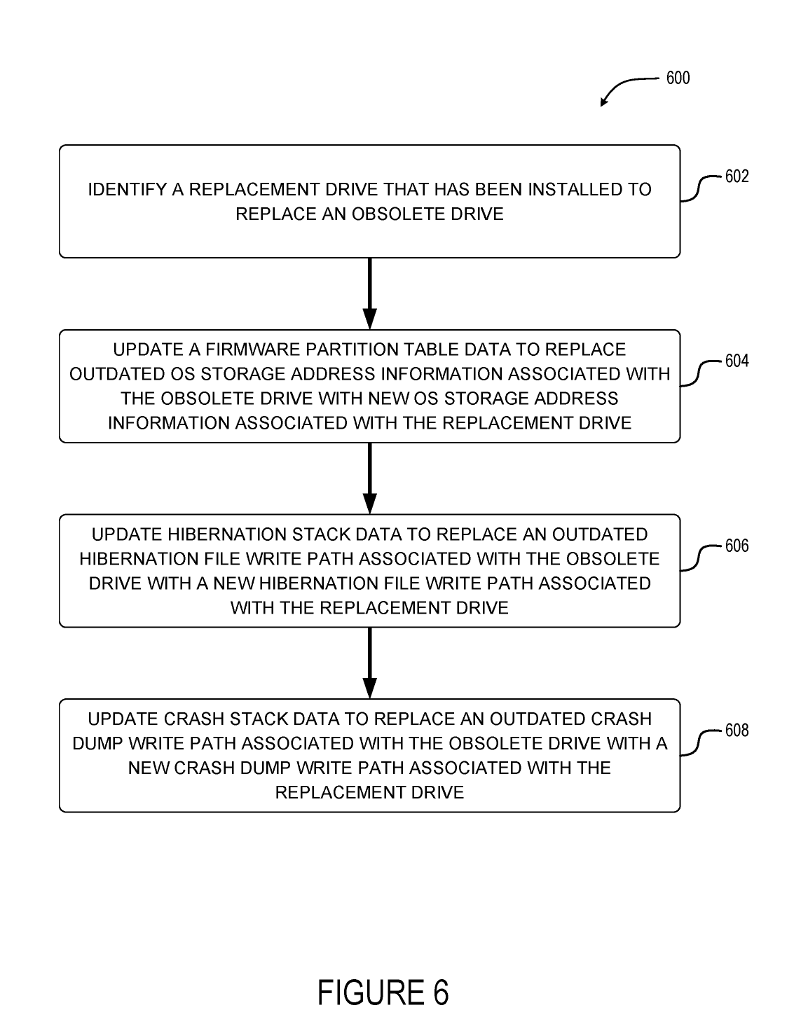

FIG. 6 is a flow diagram of an example method 600 for updating various address fields and/or write paths based on a replacement drive being installed into the computing device 204 to replace an obsolete physical drive that is removed from the computing device 204.

At block 602, the computing device 204 may identify a replacement drive that has been installed to replace an obsolete drive. In various implementations, the computing device 204 may identify the obsolete drive as being a particular physical drive that has catastrophically failed and/or has been removed from the computing device. Furthermore, the computing device may identify the replacement drive as being intended to replace the obsolete drive based on various factors. Exemplary factors include, but are not limited to, the replacement drive being plugged into the same drive port from which the obsolete drive was removed and/or an indication received from a user that the replacement drive is intended to replace the obsolete drive whether or not the replacement drive is plugged into the same drive port from which the obsolete drive was removed (or even if the obsolete drive has not been removed).

At block 604, the computing device 204 may update a firmware partition table that stores address information for the OS 122 and configuration parameters (CPs) 124 to replace outdated OS storage address information associated with the obsolete drive with new OS storage address information associated with the replacement drive. Exemplary firmware partition tables include, but are not limited to, Master Boot Record (MBR) partition tables, GUID Partition Tables (GPT), and/or APPLE Partition Maps, and/or any other suitable description of one or more partitions that reside on one or more physical drives. As used herein, the term “OS storage address information” refers generally to information that indicates to a boot manager where on the various physical drives installed within a computing device the OS 122 and configuration parameters (CPs) 124 are stored. Thus, based on the OS storage address information, a boot manager can readily determine the OS 122 and configuration parameters (CPs) 124 are stored across the multiple physical drives without performing a discovery protocol to independently discover where the OS 122 and/or configuration parameters (CPs) 124 are stored. In various implementations, updating the firmware partition table with the new OS storage address information enables a boot manager 128 of the computing device 204 to load the OS 122 and/or configuration parameters (CPs) 124 into the memory 110 from the replacement drive in accordance with an accelerated booting protocol (e.g., WINDOWS 10 Fast Startup, WINDOWS 8 Fast Boot, etc.). For example, prior to the obsolete drive failing and/or being removed from the computing device 204, the outdated OS storage address information may have indicated one or more locations on the obsolete drive from which the boot manager 128 could quickly access the OS 122 and/or configuration parameters (CPs) 124 to load into memory 110. However, upon the obsolete drive failing and/or being removed from the computing device 204, the OS storage address information associated with the obsolete drive no longer accurately indicates locations from which the OS 122 and/or configuration parameters (CPs) 124 can be accessed. Accordingly, the computing device 204 updates the firmware partition table to replace outdated OS storage address information (e.g., OS storage address information associated with the obsolete drive) with new OS storage address information indicating location(s) on the replacement drive from which the boot manager can quickly access the OS 122 and/or configuration parameters (CPs) 124 to load into the memory 110 in accordance with the accelerated booting protocol (e.g., a booting protocol which does not require the boot manager 128 to analyze the available physical drives to “discover” where the OS 122 and/or configuration parameters (CPs) 124 are stored).

Accordingly, the accelerated booting protocol may enable the firmware interface 108 and/or boot manager 128 to determine the address information corresponding to one or more locations that the OS 122 and/or configuration parameters (CPs) 124 are stored across the multiple physical drives without performing a discovery protocol to independently discover where the OS 122 and/or configuration parameters (CPs) 124 are stored. Thus, once the computing device 204 has determined the multiple redundant locations at which the OS 122 and/or configuration parameters (CPs) 124 are stored and has further determined which ones of these multiple redundant locations are currently accessible based on the operational statuses determined at block 504, the computing device may select one or more currently available physical drives to access to perform the accelerated booting protocol.

It can be appreciated that an OS may maintain stack data that defines separate write paths which are selectively utilized depending on various circumstances. For example, an exemplary OS may include a normal write path (e.g., a normal I/O path) consisting of components such as a file system, volume manager, partition manager, and/or other components that may be used by the OS during normal system operation. Such an exemplary OS may additionally include one or more alternate write paths that can be deployed to write data to a disk under specific circumstances. An exemplary alternate write path may be used exclusively for writing crash dump files to disk when the system crashes and/or for writing hibernation files to disk when the system hibernates. The separate write paths may each include a series of layered drivers (e.g., a driver stack) that passes requests back and forth to complete various operations. In some implementations, the alternate write path(s) may be a crash dump write path that includes a dump report driver, a dump miniport driver and/or one or more crash dump filter drivers.

It can be appreciated that maintaining separate write paths may be beneficial for a variety of reasons. One such reason is that when a system crash occurs it may be desirable to write a crash dump file to disk (e.g., for system auditing purposes and/or file recovery purposes). Unfortunately, utilizing the normal write path to write a crash dump file may not be possible if the cause of the system crash exists within the normal write path and/or a driver thereof (e.g., a bad pointer may exist within the normal write path rendering it unreliable or even unusable). Therefore, maintaining a crash dump write path that is completely separate from the normal write path enables a computing device to save important system data in the event of a system crash even when the system crash corrupts the normal write path. Another reason that maintaining a separate write path may be beneficial is that this separate write path may be highly optimized and lightweight to speed up disk intensive operations which must be completed very quickly such as, for example, transitioning from a normal runtime execution into a powered down hibernation mode.

Individual write paths may include information that is specific to one or more physical drives. For example, one or more drivers within a particular write path may reference address information that is specifically defined based on a discovery protocol that is used to discover a physical drive that is initially coupled to a computing device. Accordingly, the operations subsequently described with reference to blocks 606 and 608 correspond to updating stack data associated with utilizing alternate write path to write crash dump files and/or hibernation files based on one or more physical drives being replaced by one or more other physical drives.

At block 606, the computing device may update hibernation stack data to replace information indicating an outdated hibernation file write path associated with the obsolete drive with a new hibernation file write path associated with the replacement drive. In particular, since it is no longer possible to write data to the obsolete drive, the hibernation stack data may be updated to remove references to the obsolete drive (e.g., defining the outdated hibernation file write path) and insert references to the replacement drive (e.g., defining the new hibernation file write path). The hibernation stack data may also indicate address information associated with one or more blocks of non-volatile storage that are allocated to storing a hibernation file (e.g., a “hiberfil.sys” file that is generated to suspend contents of the RAM 110(1) to a physical drive). Accordingly, the outdated hibernation file write path may indicate one or more write paths through which the computing device 204 would have been able to save a hibernation file prior to the obsolete drive failing and/or being removed from the computing device 204. Furthermore, the new hibernation file write path may indicate one or more new write paths through which the computing device 204 is now able to save a hibernation file to one or more locations in the replacement drive that are specifically allocated to saving hibernation files.

At block 608, the computing device may update crash stack data to replace an outdated crash dump write path associated with the obsolete drive with a new crash dump write path associated with the replacement drive. In particular, since it is no longer possible to write data to the obsolete drive, the crash stack data may be updated to remove references to the obsolete drive (e.g., defining the outdated crash dump file write path) and insert references to the replacement drive (e.g., defining the new crash dump file write path). The crash stack update data may indicate address information associated with one or more blocks of nonvolatile storage that are allocated to storing crash dump files (e.g., “C:Windowsmemory.dmp” if C: is a system drive) that are automatically generated upon the computing device 204 crashing. Accordingly, the crash dump write path may indicate one or more write paths through which the computing device 204 would have been able to save a crash dump file prior to the obsolete drive failing and/or being removed from the computing device 204. Furthermore, the new crash dump write path may indicate one or more write paths through which the computing device 204 is now able to save a crash dump file to one or more locations in the replacement drive that are specifically allocated to saving crash dump files when the computing device 204 crashes.

In some implementations, the computing device 204 is configured to perform one or more of the operations described in relation to blocks 604 through 608 that occur automatically (e.g., without user instruction and/or input) in response to a determination that the replacement drive has been installed to replace the obsolete drive. As a more specific but nonlimiting example, the system may automatically conclude that a physical drive that is coupled to a particular drive port from which the obsolete drive has been removed is intended to be the replacement drive. Then, in response to this conclusion, a firmware interface 108 may automatically perform one or all of the operations described in relation to blocks 604 through 608.

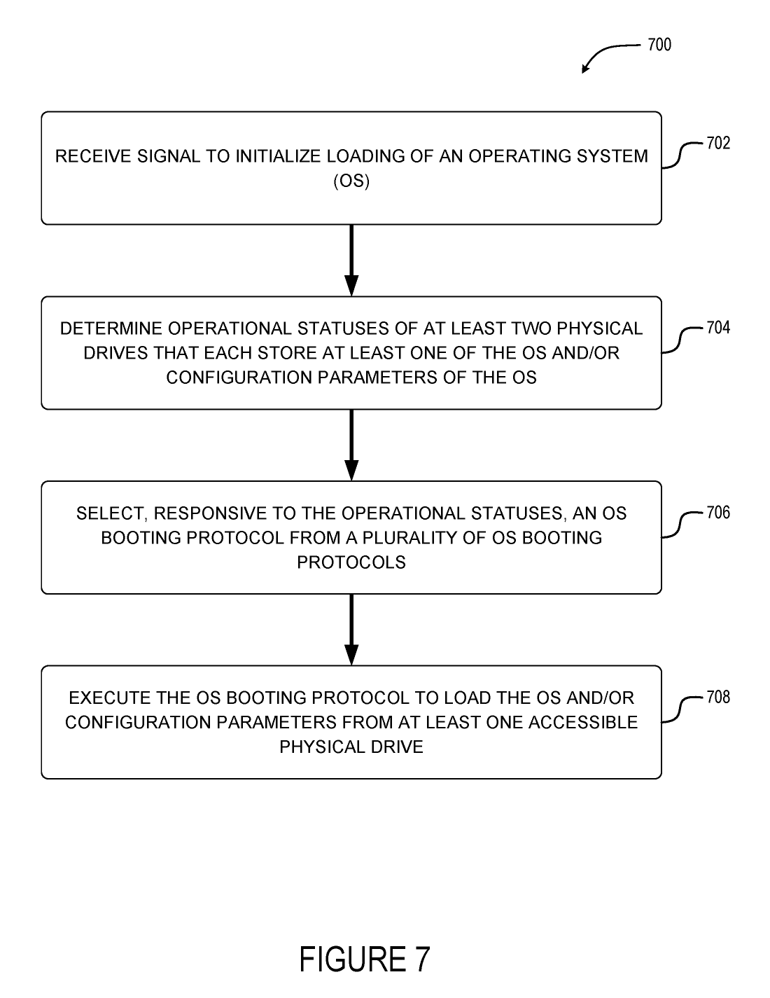

FIG. 7 is a flow diagram of an example method 700 for selecting an OS booting protocol 130 based on operational statuses of the multiple physical drives 104 that store the OS 122 and/or configuration parameters (CPs) 124. As used herein, the term “OS booting protocol” refers generally to a procedure for initializing the OS 122 and/or configuration parameters (CPs) 124 into the memory 110 to enable the computing device to run the OS 122 in accordance with the configuration parameters (CPs) 124 in a runtime environment.

At block 702, the computing device 204 may receive a signal to initialize loading of the OS 122. In some embodiments, the signal may be received by the firmware interface 108 upon a user pressing a power button on the computing device 204 at a time when the computing device 204 is completely powered down and/or is hibernating. In some embodiments, the signal may be received by the firmware interface based on a user instructing the computing device 204 to undergo a restart protocol.

At block 704, the computing device 204 may determine operational statuses for multiple physical drives 104 that are each storing at least one of the OS 122 and/or the configuration parameters (CPs) 124. For example, in a scenario in which the computing device 204 includes a first physical drive 104(1) and a second physical drive 104(2), the firmware interface 108 may perform one or more system checks with respect to each one of the first and second physical drives to determine their respective operational statuses.

At block 706, the computing device 204 (and/or one or more components thereof such as, for example, the firmware interface 108 and/or the boot manager 128) may select an OS booting protocol from the plurality of OS booting protocols 130 based on the operational statuses of the multiple physical drives 104. For example, in a scenario in which the operational statuses correspond to the first physical drive 104(1) being inaccessible and the second physical drive 104(2) being accessible, an OS booting protocol may be selected that corresponds to the OS 122 and configuration parameters (CPs) 124 being loaded into the memory 110 exclusively from the second physical drive 104(2). As another example, in a scenario in which the operational statuses correspond to both the first and second physical drives being accessible, an OS booting protocol may be selected that corresponds to the OS 122 and configuration parameters (CPs) 124 being concurrently loaded from both the first and second physical drives in order to accelerate loading (e.g., overloading from a single physical drive only). In such an example, the computing device 204 may select individual portions of the OS to be loaded into the memory 110 from the different physical drives 104 (e.g., roughly half of the OS 122 and configuration parameters (CPs) 124 may be loaded into the memory from the first physical drive whereas the other half of the OS 122 and configuration parameters (CPs) 124 may be loaded into the memory from the second physical drive).

At block 708, the computing device 204 may execute the selected OS booting protocol to load the OS 122 and/or the configuration parameters (CPs) 124 into the memory 110 from at least one physical drive that is currently accessible.

### EXAMPLE CLAUSES

The disclosure presented herein may be considered in view of the following clauses.

Example Clause A, a computing device configured to maintain resiliency of an operating system (OS), the computing device comprising: a plurality of drive ports including at least a first drive port and a second drive port; one or more processors; and a memory in communication with the one or more processors, the memory having computer-readable instructions stored thereupon which, when executed by the one or more processors, cause the computing device to: establish operation of the OS in accordance with a resilient OS mode that corresponds to at least one of the OS or configuration parameters of the OS being accessible from at least a first physical drive that is coupled to the first drive port and a second physical drive that is coupled to the second drive port; determine that an operational status of the second physical drive is associated with a transition from the resilient OS mode to a reduced OS resiliency mode, wherein the reduced OS resiliency mode corresponds to at least one of the OS or the configuration parameters being inaccessible from the second physical drive; generate, in response to the operational status of the second physical drive, a notification associated with the transition from the resilient OS mode to the reduced OS resiliency mode; receive an indication that a third physical drive has replaced the second physical drive at the second drive port; and in response to the indication, duplicate at least one of the OS or the configuration parameters onto the third physical drive to re-establish operation of the OS in accordance with the resilient OS mode; and update virtual drive metadata that defines a virtual drive that is configured to enable the computing device to operate the OS within the resilient OS mode, wherein updating the virtual drive metadata further enables a firmware interface to boot the OS from the third physical drive.

Example Clause B, the computing device of Example Clause A, wherein the computer-readable instructions further cause the computing device to: in response to the indication that the third physical drive was replaced the second physical drive at the second drive port, update the virtual drive metadata that defines the virtual drive that is configured to enable the computing device to operate the OS within the resilient OS mode, wherein updating the virtual drive metadata further enables the firmware interface to boot the OS from the third physical drive.

Example Clause C, the computing device of any one of Example Clauses A through B, wherein determining that the operational status of the second physical drive is associated with the transition comprises: receiving health data corresponding to the second physical drive; and determining, based on the health data, that a probability of the transition from the resilient OS mode to the reduced OS resiliency mode exceeds a threshold probability.

Example Clause D, the computing device of Example Clause C, wherein the computer-readable instructions further cause the computing device to: display at least one user interface element that enables a user to select an intermediary storage location for duplicating the configuration parameters prior to the third physical drive replacing the second physical drive at the second drive port.

Example Clause E, the computing device of any one of Example Clauses A through D, wherein the computer-readable instructions further cause the computing device to: subsequent to a failure of the second physical drive and prior to the third physical drive replacing the second physical drive, access the configuration parameters from the first physical drive to establish operation of the OS in accordance with the reduced OS resiliency mode.

Example Clause F, a computer-implemented method comprising: determining virtual drive metadata that defines a virtual drive as corresponding to at least a first physical drive that is coupled to a first drive port and a second physical drive that is coupled to a second drive port, wherein the virtual drive metadata is stored at least in association with a firmware interface; enabling an operating system (OS) to run from the virtual drive in accordance with a resilient OS mode by duplicating at least one of the OS or configuration parameters of the OS onto at least the first physical drive and the second physical drive; determining that an operational status of the second physical drive is associated with a transition from the resilient OS mode to a reduced OS resiliency mode; determining that a third physical drive has physically replaced the second physical drive at the second drive port; responsive to the third physical drive physically replacing the second physical drive, updating the virtual drive metadata stored on in association with the firmware interface to re-define the virtual drive as corresponding to at least the first physical drive that is coupled to the first drive port and the third physical drive that is coupled to the second drive port; and duplicating at least one of the OS or the configuration parameters to the third physical drive to re-enable the OS to operate from the virtual drive in accordance with the resilient OS mode.

Example Clause G, the computer-implemented method of Example Clause F, further comprising: based on the duplicating at least one of the OS or the configuration parameters to the third physical drive, updating a partition table to enable at least one boot manager to load the configuration parameters into a memory device from the third physical drive in accordance with an accelerated booting protocol.

Example Clause H, the computer-implemented method of any one of Example Clauses F through G, wherein enabling the OS to operate from the virtual drive in accordance with the resilient OS mode includes facilitating concurrent access to at least one of the OS or the configuration parameters from at least two physical drives.

Example Clause I, the computer-implemented method of Example Clause H, wherein the configuration parameters are stored at least in a firmware interface system partition that is synchronized between the at least two physical drives.

Example Clause J, the computer-implemented method of any one of Example Clauses F through I, wherein determining that the operational status of the second physical drive is associated with the transition to the reduced OS resiliency mode includes: determining that the second physical drive has been physically de-coupled from the second drive port.

Example Clause K, the computer-implemented method of any one of Example Clauses F through J, wherein determining that the operational status of the second physical drive is associated with the transition to the reduced OS resiliency mode includes: determining, based on the operational status, that a probability of the transition from the resilient OS mode to the reduced OS resiliency mode exceeds a threshold probability.

Example Clause L, the computer-implemented method of Example Clause K, further comprising: generating, in response to the probability of the transition exceeding the threshold probability, a notification that indicates the probability of the transition from the resilient OS mode to the reduced OS resiliency mode.

Example Clause M, the computer-implemented method of any one of Example Clauses F through L, further comprising: responsive to the operational status of the second physical drive resulting in the transition, causing a display of a user interface element that indicates that the OS is currently operating in the reduced OS resiliency mode.

Example Clause N, the computer-implemented method of any one of Example Clauses F through M, further comprising: responsive to the third physical drive replacing the second physical drive, updating hibernation stack data to replace an outdated hibernation file write path associated with the second physical drive with a new hibernation file write path associated with the third physical drive.

Example Clause O, the computer-implemented method of any one of Example Clauses F through N, further comprising: responsive to the third physical drive replacing the second physical drive, updating crash stack data to replace an outdated crash dump write path associated with the second physical drive with a new crash dump write path associated with the third physical drive.

Example Clause P, a computing device, comprising: one or more processors; a memory in communication with the one or more processors; a first drive port coupled to a first physical drive and a second drive port coupled to a second physical drive, wherein each of the first physical drive and the second physical drive store at least one of an operating system (OS) or configuration parameters corresponding to the OS; a firmware interface configured to selectively access at least the first physical drive and the second physical drive, the firmware interface having computer-executable instructions stored thereupon that are executable by the one or more processors to: receive a signal to initialize loading of the OS into the memory; determine, in response to the signal, a first operational status of the first physical drive and a second operational status of the second physical drive; based on the first operation status and the second operational status, select an OS booting protocol from a plurality of OS booting protocols, the OS booting protocol designating at least the first physical drive for booting the OS; and accessing the first physical drive to load at least a portion of a first instance of the OS into the memory in accordance with the OS booting protocol.

Example Clause Q, the computing device of Example Clause P, wherein the OS booting protocol is selected based, at least in part, on the first operational status indicating that the first physical drive is accessible to the firmware interface and the second operational status indicating that the second physical drive is inaccessible to the firmware interface.

Example Clause R, the computing device of any one of Example Clauses P through Q, wherein the firmware interface includes at least one firmware variable that is accessible, during operation of the OS from the memory, to record update parameters associated with one or more updates to the configuration parameters, and wherein the update parameters indicate whether the first instance of the OS is outdated with respect to a second instance of the OS corresponding to the second physical drive.

Example Clause S, the computing device of Example Clause R, wherein the computer-executable instructions stored on the firmware interface are further executable by the one or more processors to: determine, based on the update parameters, that the first instance of the OS is outdated with respect to the second instance of the OS; and generate a notification that indicates that the first instance of the OS is outdated with respect to the second instance of the OS, wherein the notification includes at least one user interface element that is configured to enable a user to indicate whether to load the at least the portion of the first instance into the memory.

Example Clause T, the computing device of any one of Example Clauses P through S, wherein the OS booting protocol further designates the second physical drive for loading the OS into the memory, and wherein the computer-executable instructions stored on the firmware interface are further executable by the one or more processors to access the second physical drive to load at least a portion of a second instance of the OS into the memory in accordance with the OS booting protocol.

### CONCLUSION

In closing, although the various techniques have been described in language specific to structural features and/or methodological acts, it is to be understood that the subject matter defined in the appended representations is not necessarily limited to the specific features or acts described. Rather, the specific features and acts are disclosed as example forms of implementing the claimed subject matter.

What is claimed is:

1. A computing device configured to maintain resiliency of an operating system (OS), the computing device comprising:
a plurality of drive ports including at least a first drive port and a second drive port;
one or more processors; and
a memory in communication with the one or more processors, the memory having computer-readable instructions stored thereupon which, when executed by the one or more processors, cause the computing device to:
establish operation of the OS in accordance with a resilient OS mode that corresponds to at least one of the OS or configuration parameters of the OS being accessible from at least a first physical drive that is coupled to the first drive port and a second physical drive that is coupled to the second drive port;
determine that an operational status of the second physical drive is associated with a transition from the resilient OS mode to a reduced OS resiliency mode, wherein the reduced OS resiliency mode corresponds to at least one of the OS or the configuration parameters being inaccessible from the second physical drive;
generate, in response to the operational status of the second physical drive, a notification associated with the transition from the resilient OS mode to the reduced OS resiliency mode;
receive an indication that a third physical drive has replaced the second physical drive at the second drive port; and
in response to the indication, duplicate at least one of the OS or the configuration parameters onto the third physical drive to re-establish operation of the OS in accordance with the resilient OS mode; and
update virtual drive metadata that defines a virtual drive that is configured to enable the computing device to operate the OS within the resilient OS mode, wherein updating the virtual drive metadata further enables a firmware interface to boot the OS from the third physical drive.

2. The computing device of claim 1, wherein the computer-readable instructions further cause the computing device to:
in response to the indication that the third physical drive was replaced the second physical drive at the second drive port, update the virtual drive metadata that defines the virtual drive that is configured to enable the computing device to operate the OS within the resilient OS mode, wherein updating the virtual drive metadata further enables the firmware interface to boot the OS from the third physical drive.

3. The computing device of claim 1, wherein determining that the operational status of the second physical drive is associated with the transition comprises:
receiving health data corresponding to the second physical drive; and
determining, based on the health data, that a probability of the transition from the resilient OS mode to the reduced OS resiliency mode exceeds a threshold probability.

4. The computing device of claim 3, wherein the computer-readable instructions further cause the computing device to:
display at least one user interface element that enables a user to select an intermediary storage location for duplicating the configuration parameters prior to the third physical drive replacing the second physical drive at the second drive port.

5. The computing device of claim 1, wherein the computer-readable instructions further cause the computing device to:
subsequent to a failure of the second physical drive and prior to the third physical drive replacing the second physical drive, access the configuration parameters from the first physical drive to establish operation of the OS in accordance with the reduced OS resiliency mode.

6. A computer-implemented method comprising:
determining virtual drive metadata that defines a virtual drive as corresponding to at least a first physical drive that is coupled to a first drive port and a second physical drive that is coupled to a second drive port, wherein the virtual drive metadata is stored at least in association with a firmware interface;
enabling an operating system (OS) to run from the virtual drive in accordance with a resilient OS mode by duplicating at least one of the OS or configuration parameters of the OS onto at least the first physical drive and the second physical drive;
determining that an operational status of the second physical drive is associated with a transition from the resilient OS mode to a reduced OS resiliency mode;
determining that a third physical drive has physically replaced the second physical drive at the second drive port;
responsive to the third physical drive physically replacing the second physical drive, updating the virtual drive metadata stored on in association with the firmware interface to re-define the virtual drive as corresponding to at least the first physical drive that is coupled to the first drive port and the third physical drive that is coupled to the second drive port; and
duplicating at least one of the OS or the configuration parameters to the third physical drive to re-enable the OS to operate from the virtual drive in accordance with the resilient OS mode.

7. The computer-implemented method of claim 6, further comprising:
based on the duplicating at least one of the OS or the configuration parameters to the third physical drive, updating a partition table to enable at least one boot manager to load the configuration parameters into a memory device from the third physical drive in accordance with an accelerated booting protocol.

8. The computer-implemented method of claim 6, wherein enabling the OS to operate from the virtual drive in accordance with the resilient OS mode includes facilitating concurrent access to at least one of the OS or the configuration parameters from at least two physical drives.

9. The computer-implemented method of claim 8, wherein the configuration parameters are stored at least in a firmware interface system partition that is synchronized between the at least two physical drives.

10. The computer-implemented method of claim 6, wherein determining that the operational status of the second physical drive is associated with the transition to the reduced OS resiliency mode includes:
determining that the second physical drive has been physically de-coupled from the second drive port.

11. The computer-implemented method of claim 6, wherein determining that the operational status of the second physical drive is associated with the transition to the reduced OS resiliency mode includes:
determining, based on the operational status, that a probability of the transition from the resilient OS mode to the reduced OS resiliency mode exceeds a threshold probability.

12. The computer-implemented method of claim 11, further comprising:
generating, in response to the probability of the transition exceeding the threshold probability, a notification that indicates the probability of the transition from the resilient OS mode to the reduced OS resiliency mode.

13. The computer-implemented method of claim 6, further comprising:
responsive to the operational status of the second physical drive resulting in the transition, causing a display of a user interface element that indicates that the OS is currently operating in the reduced OS resiliency mode.

14. The computer-implemented method of claim 6, further comprising:
responsive to the third physical drive replacing the second physical drive, updating hibernation stack data to replace an outdated hibernation file write path associated with the second physical drive with a new hibernation file write path associated with the third physical drive.

15. The computer-implemented method of claim 6, further comprising:
responsive to the third physical drive replacing the second physical drive, updating crash stack data to replace an outdated crash dump write path associated with the second physical drive with a new crash dump write path associated with the third physical drive.

16. A computing device, comprising:
one or more processors;
a memory in communication with the one or more processors;
a first drive port coupled to a first physical drive and a second drive port coupled to a second physical drive, wherein each of the first physical drive and the second physical drive store at least one of an operating system (OS) or configuration parameters corresponding to the OS;
a firmware interface configured to selectively access at least the first physical drive and the second physical drive, the firmware interface having computer-executable instructions stored thereupon that are executable by the one or more processors to:
receive a signal to initialize loading of the OS into the memory;
determine, in response to the signal, a first operational status of the first physical drive and a second operational status of the second physical drive;
based on the first operation status and the second operational status, select an OS booting protocol from a plurality of OS booting protocols, the OS booting protocol designating at least the first physical drive for booting the OS; and
accessing the first physical drive to load at least a portion of a first instance of the OS into the memory in accordance with the OS booting protocol.

17. The computing device of claim 16, wherein the OS booting protocol is selected based, at least in part, on the first operational status indicating that the first physical drive is accessible to the firmware interface and the second operational status indicating that the second physical drive is inaccessible to the firmware interface.

18. The computing device of claim 16, wherein the firmware interface includes at least one firmware variable that is accessible, during operation of the OS from the memory, to record update parameters associated with one or more updates to the configuration parameters, and wherein the update parameters indicate whether the first instance of the OS is outdated with respect to a second instance of the OS corresponding to the second physical drive.

19. The computing device of claim 18, wherein the computer-executable instructions stored on the firmware interface are further executable by the one or more processors to:
determine, based on the update parameters, that the first instance of the OS is outdated with respect to the second instance of the OS; and
generate a notification that indicates that the first instance of the OS is outdated with respect to the second instance of the OS, wherein the notification includes at least one user interface element that is configured to enable a user to indicate whether to load the at least the portion of the first instance into the memory.

20. The computing device of claim 16, wherein the OS booting protocol further designates the second physical drive for loading the OS into the memory, and wherein the computer-executable instructions stored on the firmware interface are further executable by the one or more processors to access the second physical drive to load at least a portion of a second instance of the OS into the memory in accordance with the OS booting protocol.
